(19) United States
(12) Patent Application Publication
(10) Pub. No.: US 2025/0089074 A1
(43) Pub. Date: Mar. 13, 2025

(54) COMMUNICATION METHOD AND TERMINAL DEVICE

(71) Applicant: GUANGDONG OPPO MOBILE TELECOMMUNICATIONS CORP., LTD., Dongguan (CN)

(72) Inventors: Shichang ZHANG, Dongguan (CN); Teng MA, Dongguan (CN); Zhenshan ZHAO, Dongguan (CN)

(21) Appl. No.: 18/959,950

(22) Filed: Nov. 26, 2024

Related U.S. Application Data
(63) Continuation of application No. PCT/CN2022/110825, filed on Aug. 8, 2022.

(51) Int. Cl. H04W 72/25; H04L 5/00

(52) U.S. Cl. CPC H04W 72/25; H04L 5/0051

(57) ABSTRACT

Provided are a communication method and a terminal device. The method includes: sending, by a first terminal device, first indication information to a second terminal device, where the first indication information is used to indicate reserving a first SL PRS resource in an SL PRS resource pool, and the first SL PRS resource satisfies one of the following: a time domain unit in which the first SL PRS resource is located is the same as a time domain unit in which the first indication information is located; the first SL PRS resource is an SL PRS resource other than a resource used for sidelink communication in the SL PRS resource pool; or a second SL PRS resource included in the first SL PRS resource overlaps a resource that is used by the second terminal device for sidelink communication in a sidelink communication resource pool.

This application is a continuation of International Application No. PCT/CN2022/110825, filed on Aug. 8, 2022, the disclosure of which is hereby incorporated by reference in its entirety.

### TECHNICAL FIELD

This application relates to the field of communications technologies, and more specifically, to a communication method and a terminal device.

### BACKGROUND

A sidelink positioning reference signal (SL PRS) resource may overlap a resource used for sidelink communication. In this case, if a first terminal device reserves an SL PRS resource (also referred to as a “first SL PRS resource”) for sending an SL PRS, the SL PRS on the first SL PRS resource may collide with a sidelink signal sent by another terminal device. In other words, the first SL PRS resource may collide with a resource used by a second terminal device for sidelink communication.

### SUMMARY

This application provides a communication method and a terminal device. The following describes aspects related to this application.

According to a first aspect, a communication method is provided, including: sending, by a first terminal device, first indication information to a second terminal device, where the first indication information is used to indicate reserving a first SL PRS resource in an SL PRS resource pool, and the first SL PRS resource satisfies one of the following: a time domain unit in which the first SL PRS resource is located is the same as a time domain unit in which the first indication information is located; the first SL PRS resource is an SL PRS resource other than a resource used for sidelink communication in the SL PRS resource pool; or a second SL PRS resource included in the first SL PRS resource overlaps a resource that is used by the second terminal device for sidelink communication in a sidelink communication resource pool.

According to a second aspect, a communication method is provided, including: receiving, by a second terminal device, first indication information sent by a first terminal device, where the first indication information is used to indicate reserving a first SL PRS resource in an SL PRS resource pool, and the first SL PRS resource satisfies one of the following: a time domain unit in which the first SL PRS resource is located is the same as a time domain unit in which the first indication information is located; the first SL PRS resource is an SL PRS resource other than a resource used for sidelink communication in the SL PRS resource pool; or a second SL PRS resource in the first SL PRS resource overlaps a resource that is used by the second terminal device for sidelink communication in a sidelink communication resource pool.

According to a third aspect, a first terminal device is provided, including: a sending unit, configured to send first indication information to a second terminal device, where the first indication information is used to indicate reserving a first SL PRS resource in an SL PRS resource pool, and the first SL PRS resource satisfies one of the following: a time domain unit in which the first SL PRS resource is located is the same as a time domain unit in which the first indication information is located; the first SL PRS resource is an SL PRS resource other than a resource used for sidelink communication in the SL PRS resource pool; or a second SL PRS resource included in the first SL PRS resource overlaps a resource that is used by the second terminal device for sidelink communication in a sidelink communication resource pool.

According to a fourth aspect, a second terminal device is provided, including: a receiving unit, configured to receive first indication information sent by a first terminal device, where the first indication information is used to indicate reserving a first SL PRS resource in an SL PRS resource pool, and the first SL PRS resource satisfies one of the following: a time domain unit in which the first SL PRS resource is located is the same as a time domain unit in which the first indication information is located; the first SL PRS resource is an SL PRS resource other than a resource used for sidelink communication in the SL PRS resource pool; or a second SL PRS resource included in the first SL PRS resource overlaps a resource that is used by the second terminal device for sidelink communication in a sidelink communication resource pool.

According to a fifth aspect, a terminal device is provided, including a processor, a memory, and a communications interface. The memory is configured to store one or more computer programs. The processor is configured to invoke the computer program in the memory, to cause the terminal device to perform some or all of the steps of the method in the foregoing aspect.

According to a sixth aspect, an embodiment of this application provides a communications system. The system includes the terminal device described above and/or a network device. In another possible design, the system may further include another device that interacts with the terminal device or the network device in the solutions provided in embodiments of this application.

According to a seventh aspect, an embodiment of this application provides a computer-readable storage medium. The computer-readable storage medium stores a computer program. The computer program causes a communications device (for example, a terminal device or a network device) to perform some or all of the steps of the method in each of the foregoing aspects.

According to an eighth aspect, an embodiment of this application provides a computer program product. The computer program product includes a non-transitory computer-readable storage medium that stores a computer program. The computer program is operable to cause a communications device (for example, a terminal device or a network device) to perform some or all of the steps of the method in each of the foregoing aspects. In some implementations, the computer program product may be a software installation package.

According to a ninth aspect, an embodiment of this application provides a chip. The chip includes a memory and a processor. The processor may invoke a computer program from the memory and run the computer program, to implement some or all of the steps described in the method in each of the foregoing aspects.

### BRIEF DESCRIPTION OF DRAWINGS

FIG. 1 is an example diagram of a system architecture of a wireless communications system to which an embodiment of this application is applicable.

FIG. 2 is an example diagram of a scenario of sidelink communication within network coverage.

FIG. 3 is an example diagram of a scenario of sidelink communication with partial network coverage.

FIG. 4 is an example diagram of a scenario of sidelink communication outside network coverage.

FIG. 5 is an example diagram of a scenario of sidelink communication based on a central control node.

FIG. 6 is an example diagram of a broadcast-based sidelink communication manner.

FIG. 7 is an example diagram of a unicast-based sidelink communication manner.

FIG. 8 is an example diagram of a multicast-based sidelink communication manner.

FIG. 9 is a schematic diagram of PSCCH and PSSCH multiplexing manners in LTE-V2X and NR-V2X systems.

FIG. 10 is a schematic diagram of PSCCH and PSSCH resource pools.

FIG. 11 is a schematic diagram of a subframe in an NR system.

FIG. 12 is a schematic diagram of symbols used for sidelink transmission in a slot.

FIG. 13 is a schematic diagram of a sidelink resource selection manner.

FIG. 14 is a schematic diagram of time domain locations of two resource pools according to an embodiment of this application.

FIG. 15 is a schematic diagram of time domain locations of two resource pools according to another embodiment of this application.

FIG. 16 is a schematic flowchart of a communication method according to an embodiment of this application.

FIG. 17 is a schematic diagram of time domain locations of two resource pools according to another embodiment of this application.

FIG. 18 is a schematic diagram of a terminal device according to an embodiment of this application.

FIG. 19 is a schematic diagram of a terminal device according to an embodiment of this application.

FIG. 20 is a schematic diagram of a structure of a communications apparatus according to an embodiment of this application.

### DESCRIPTION OF EMBODIMENTS

The technical solutions in this application are described below with reference to the accompanying drawings.

### Communications System Architecture

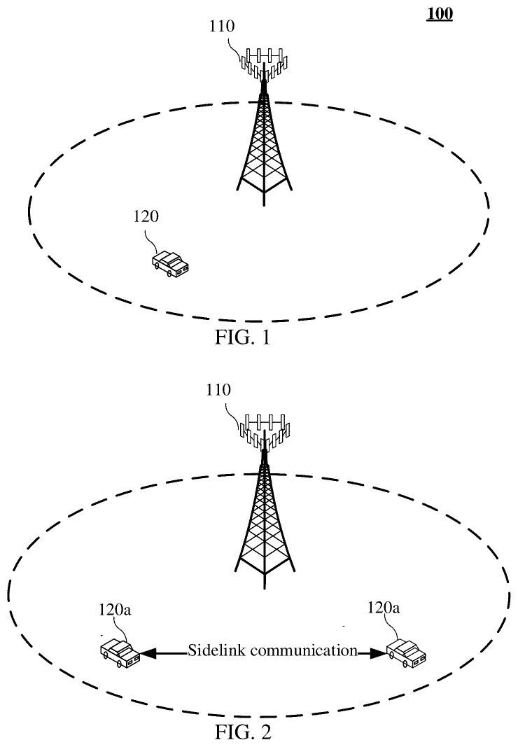

FIG. 1 is an example diagram of a system architecture of a wireless communications system 100 to which an embodiment of this application is applicable. The wireless communications system 100 may include a network device 110 and a terminal device 120. The network device 110 may be a device that communicates with the terminal device 120. The network device 110 may provide communication coverage for a specific geographic area, and may communicate with the terminal device 120 located within the coverage.

FIG. 1 shows an example in which there is one network device and one terminal device. Optionally, the wireless communications system 100 may include one or more network devices 110 and/or one or more terminal devices 120. For the network device 110, the one or more terminal devices 120 may be located within the network coverage of the network device 110, may be located outside the network coverage of the network device 110, or may be located partially within the coverage of the network device 110 and partially outside the network coverage of the network device 110. This is not limited in embodiments of this application.

Optionally, the wireless communications system 100 may further include another network entity such as a network controller or a mobility management entity. This is not limited in embodiments of this application.

It should be understood that the technical solutions of embodiments of this application may be applied to various communications systems, such as a 5th generation (5G) system or new radio (NR), a long-term evolution (LTE) system, an LTE frequency division duplex (FDD) system, and LTE time division duplex (TDD). The technical solutions provided in this application may further be applied to a future communications system, such as a 6th generation mobile communications system or a satellite communications system.

The terminal device in embodiments of this application may alternatively be referred to as user equipment (UE), an access terminal, a subscriber unit, a subscriber station, a mobile site, a mobile station (MS), a mobile terminal (MT), a remote station, a remote terminal device, a mobile device, a user terminal, a wireless communications device, a user agent, or a user apparatus. The terminal device in embodiments of this application may be a device providing a user with voice and/or data connectivity and capable of connecting people, objects, and machines, such as a handheld device or an in-vehicle device having a wireless connection function. The terminal device in embodiments of this application may be a mobile phone, a tablet computer (Pad), a notebook computer, a palmtop computer, a mobile Internet device (MID), a wearable device, a vehicle, a wireless terminal in industrial control, a wireless terminal in self driving, a wireless terminal in remote medical surgery, a wireless terminal in a smart grid, a wireless terminal in transportation safety, a wireless terminal in a smart city, a wireless terminal in a smart home, or the like. For example, the terminal device may function as a scheduling entity that provides a sidelink signal between terminal devices in vehicle-to-everything (V2X) communication, device-to-device (D2D) communication, or the like. For example, a cellular phone and a vehicle communicate with each other by using a sidelink signal. A cellular phone and a smart home device communicate with each other, without the relay of a communication signal by using a base station. Optionally, the terminal device may function as a base station.

The network device in embodiments of this application may be a device for communicating with the terminal device. The network device may also be referred to as an access network device or a radio access network device. For example, the network device may be a base station. The network device in embodiments of this application may be a radio access network (RAN) node (or device) that connects the terminal device to a wireless network. The base station may broadly cover various names below, or may be replaced with the following names, such as a NodeB, an evolved NodeB (eNB), a next generation NodeB (gNB), a relay station, an access point, a transmitting and receiving point (TRP), a transmitting point (TP), a master MeNB, a secondary SeNB, a multi-standard radio (MSR) node, a home base station, a network controller, an access node, a wireless node, an access point (AP), a transmission node, a transceiver node, a baseband unit (BBU), a remote radio unit (RRU), an active antenna unit (AAU), a remote radio head (RRH), a central unit (CU), a distributed unit (DU), and a positioning node. The base station may be a macro base station, a micro base station, a relay node, a donor node, or the like, or a combination thereof. Alternatively, the base station may be a communications module, a modem, or a chip disposed in the device or the apparatus described above. Alternatively, the base station may be a mobile switching center, a device that assumes the function of a base station in device-to-device D2D, V2X, and machine-to-machine (M2M) communications, a network-side device in a 6G network, a device that assumes the function of a base station in a future communications system, or the like. The base station may support networks with a same access technology or different access technologies. A specific technology and a specific device form used by the network device are not limited in embodiments of this application.

The base station may be fixed or mobile. For example, a helicopter or an unmanned aerial vehicle may be configured to function as a mobile base station, and one or more cells may move according to a location of the mobile base station. In other examples, a helicopter or an unmanned aerial vehicle may be configured to function as a device that communicates with another base station.

In some deployments, the network device in embodiments of this application may be a CU or a DU, or the network device includes a CU and a DU. The gNB may further include an AAU.

The network device and the terminal device may be deployed on land, including being deployed indoors or outdoors, handheld, or vehicle-mounted, may be deployed on a water surface, or may be deployed on a plane, a balloon, or a satellite in the air. In embodiments of this application, a scenario in which the network device and the terminal device are located is not limited.

### Sidelink Communication in Different Network Coverage Statuses

Sidelink communication means a sidelink-based communication technology. Sidelink communication may be, for example, device-to-device (D2D) communication or vehicle-to-everything (V2X) communication. In a conventional cellular system, communication data is received or sent between a terminal device and a network device. Sidelink communication supports direct transmission of communication data between terminal devices. In comparison with conventional cellular communication, direct transmission of the communication data between terminal devices may have higher spectral efficiency and a lower transmission delay. For example, an Internet of vehicles system uses a sidelink communication technology.

Sidelink communication may be classified, depending on a network coverage status of the terminal device, into sidelink communication within network coverage, sidelink communication with partial network coverage, and sidelink communication outside network coverage.

FIG. 2 is an example diagram of a scenario of sidelink communication within network coverage. In the scenario shown in FIG. 2, two terminal devices 120a are both located within coverage of a network device 110. Therefore, both the two terminal devices 120a may receive configuration signalling (where the configuration signalling in this application may alternatively be replaced with configuration information) from the network device 110, and determine a sidelink configuration based on the configuration signalling from the network device 110. After performing sidelink configuration, both the two terminal devices 120a may perform sidelink communication on a sidelink.

FIG. 3 is an example diagram of a scenario of sidelink communication with partial network coverage. In the scenario shown in FIG. 3, a terminal device 120a performs sidelink communication with a terminal device 120b. The terminal device 120a is located within coverage of a network device 110. Therefore, the terminal device 120a can receive configuration signalling from the network device 110, and determine a sidelink configuration based on the configuration signalling from the network device 110. The terminal device 120b is located outside network coverage, and cannot receive the configuration signalling from the network device 110. In this case, the terminal device 120b may determine a sidelink configuration based on preconfiguration information and/or information that is carried on a physical sidelink broadcast channel (PSBCH) and that is sent by the terminal device 120a located within the network coverage. After performing sidelink configuration, both the terminal device 120a and the terminal device 120b may perform sidelink communication on a sidelink.

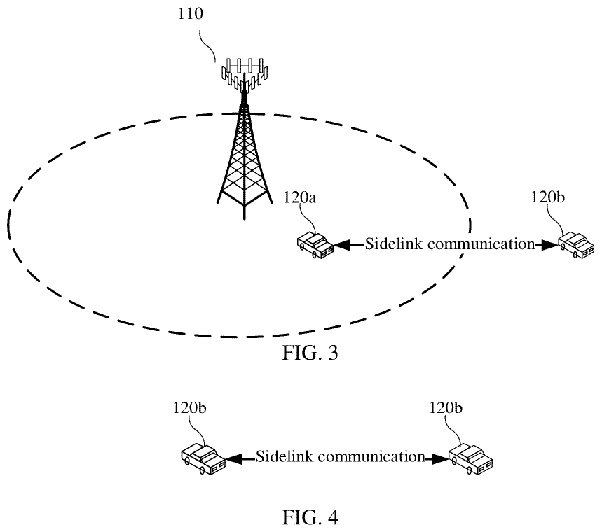

FIG. 4 is an example diagram of a scenario of sidelink communication outside network coverage. In the scenario shown in FIG. 4, two terminal devices 120b are both located outside network coverage. In this case, both the two terminal devices 120b may determine a sidelink configuration based on preconfiguration information. After performing sidelink configuration, both the two terminal devices 120b may perform sidelink communication on a sidelink.

### Sidelink Communication Based on a Central Control Node

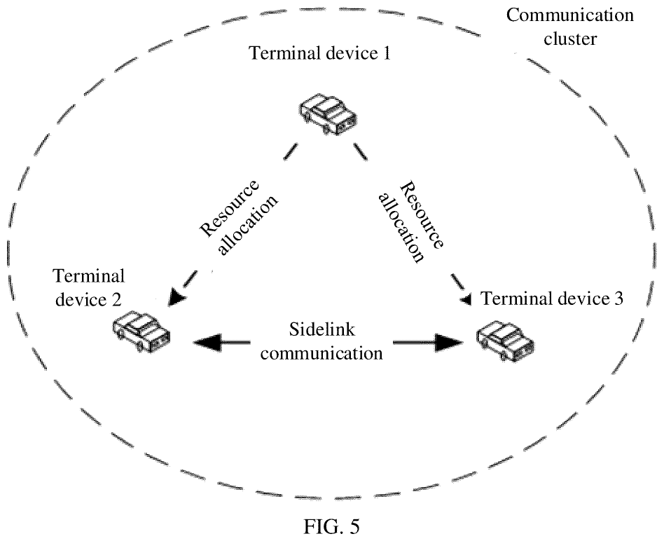

FIG. 5 is an example diagram of a scenario of sidelink communication based on a central control node. In the sidelink communication scenario, a plurality of terminal devices may form a communication cluster, and the communication cluster has a central control node. The central control node may be a terminal device (for example, a terminal device 1 in FIG. 5) in the communication cluster. The terminal device may also be referred to as a cluster header (CH) terminal device. The central control node may be responsible for completing one or more of the following functions: establishment of the communication cluster, joining and leaving of a member in the communication cluster, resource coordination in the communication cluster, allocation of sidelink transmission resources for another terminal device, reception of sidelink feedback information from another terminal device, or resource coordination with another communication cluster.

### Data Transmission Modes of Sidelink Communication

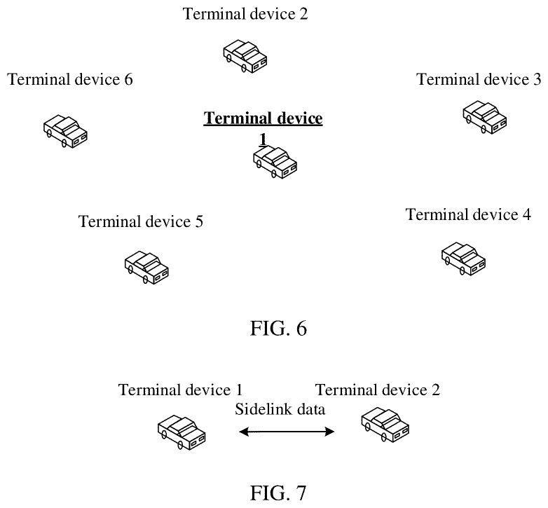

Some sidelink communications systems (for example, long term evolution vehicle-to-everything (LTE-V2X)) support broadcast-based data transmission (hereinafter referred to as broadcast transmission). For broadcast transmission, a receive-end terminal may be any terminal device around a transmit-end terminal. For example, in FIG. 6, a terminal device 1 is a transmit-end terminal, and a receive-end terminal corresponding to the transmit-end terminal is any terminal device around the terminal device 1, for example, may be a terminal device 2 to a terminal device 6 in FIG. 6.

In addition to broadcast transmission, some communications systems also support a unicast-based data transmission mode (referred to as unicast transmission for short below) and/or a multicast-based data transmission mode (referred to as multicast transmission for short below). For example, it is desired that new radio vehicle-to-everything (NR-V2X) supports self-driving. Self-driving poses higher requirements for data interaction between vehicles. For example, data interaction between vehicles requires a higher throughput, a lower delay, higher reliability, larger coverage, and a more flexible resource allocation manner. Therefore, to improve performance of data interaction between vehicles, NR-V2X introduces unicast transmission and multicast transmission.

For unicast transmission, a receive-end terminal usually has only one terminal device. For example, in FIG. 7, unicast transmission is performed between a terminal device 1 and a terminal device 2. The terminal device 1 may be a transmit-end terminal, and the terminal device 2 may be a receive-end terminal. Alternatively, the terminal device 1 may be a receive-end terminal, and the terminal device 2 may be a transmit-end terminal.

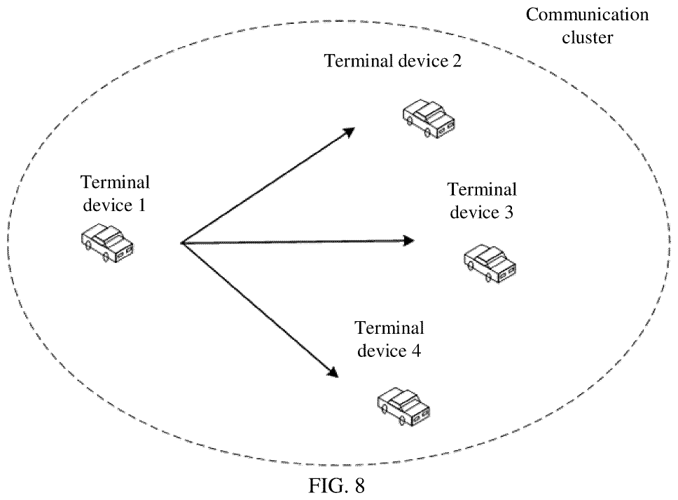

For multicast transmission, the receive-end terminal may be a terminal device in a communication cluster, or the receive-end terminal may be a terminal device within a specific transmission distance. For example, in FIG. 8, a terminal device 1, a terminal device 2, a terminal device 3, and a terminal device 4 constitute a communication cluster. If the terminal device 1 sends data, all other terminal devices (the terminal device 2 to the terminal device 4) in the cluster may be receive-end terminals.

### NR-V2X Slot Structure

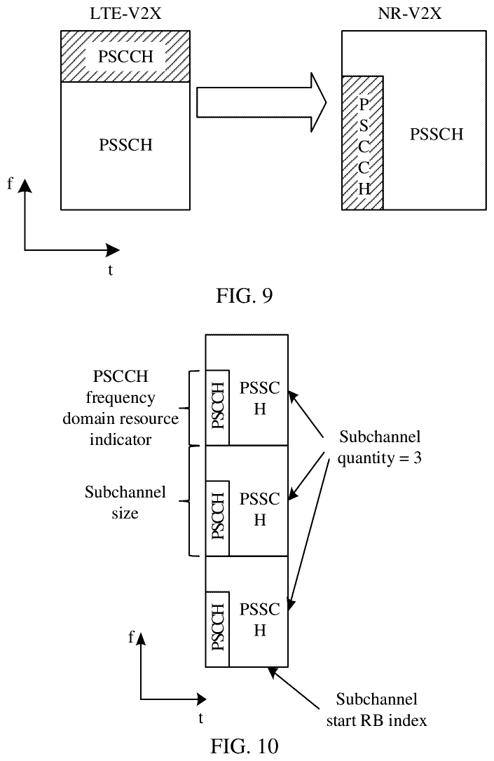

An NR-V2X system has a lower delay than an LTE-V2X system. Therefore, a PSCCH and PSSCH multiplexing manner in the NR-V2X system is redesigned relative to the LTE-V2X system. FIG. 9 is a schematic diagram of PSCCH and PSSCH multiplexing manners in LTE-V2X and NR-V2X systems. With reference to FIG. 9, in the LTE-V2X system, a terminal device only detects a PSSCH after completing receiving a PSCCH. This multiplexing manner increases a delay. However, in the NR-V2X system, a PSCCH may occupy two or three OFDM symbols other than an AGC symbol, and a PSCCH time domain location may start from the second time domain symbol (the first time domain symbol is the AGC symbol) of time domain symbols that can be used for sidelink transmission in a slot. A quantity of PRBs occupied by the PSCCH in frequency domain is configurable.

### Determining of an NR-V2X Frequency Domain Resource

Similar to LTE-V2X, a frequency domain resource of an NR-V2X resource pool may be consecutive, and an allocation granularity of the frequency domain resource may be a sub-channel. Generally, a quantity of physical resource blocks PRBs included in one sub-channel is {10, 12, 15, 20, 50, 75, 100}, where a minimum size of a sub-channel is 10 PRBs, that is, far greater than a minimum size of a sub-channel in LTE-V2X, i.e., 4 PRBs. This is mainly because a frequency domain resource of a physical sidelink control channel (PSCCH) in NR-V2X is located on a first sub-channel of a PSSCH associated with the PSCCH. A quantity of frequency domain resources of the PSCCH is less than or equal to a size of a sub-channel of the physical sidelink shared channel (PSSCH), and the PSCCH occupies time domain resources of two or three OFDM symbols. If a size of the sub-channel is configured relatively small, available resources for the PSCCH is little, a bit rate is improved, and detection performance of the PSCCH is reduced. In NR-V2X, a size of a sub-channel of a PSSCH and a quantity of frequency domain resources of a PSCCH are independently configured. However, generally, the quantity of the frequency domain resources of the PSCCH is less than or equal to the size of the sub-channel of the PSSCH.

In some implementations, the following configuration parameters in NR-V2X resource pool configuration information are used to determine frequency domain resources of a PSCCH resource pool and a PSSCH resource pool: a sub-channel size (sl-SubchannelSize), a sub-channel quantity (sl-NumSubchannel), a sub-channel start RB index (sl-StartRB-Subchannel), a PRB quantity (sl-RB-Number), and a PSCCH frequency domain resource indicator (sl-FreqResourcePSCCH).

The foregoing sub-channel size may indicate a quantity of consecutive PRBs included in one sub-channel in a resource pool. A value range may be {10, 12, 15, 20, 50, 75, 100} PRBs.

The foregoing sub-channel quantity may indicate a quantity of sub-channels included in a resource pool.

The foregoing sub-channel start RB index may indicate a start PRB index of the first sub-channel in a resource pool.

The foregoing PRB quantity may indicate a quantity of consecutive PRBs included in a resource pool.

The foregoing PSCCH frequency domain resource indicator may indicate a size of a frequency domain resource of a PSCCH. Usually, a value range is {10, 12, 15, 20, 25} PRBs.

In some implementations, when the terminal device determines a resource pool used for PSSCH sending or receiving, a frequency domain resource included in the resource pool may be sl-NumSubchannel consecutive sub-channels starting from a PRB indicated by sl-StartRB-Subchannel. If a quantity of PRBs included in the sl-NumSubchannel consecutive sub-channels is less than the PRB quantity indicated by sl-RB-Number, remaining PRBs cannot be used for PSSCH sending or receiving.

In NR-V2X, a frequency domain start location of the PSCCH may be aligned with a frequency domain start location of the first sub-channel of the PSSCH associated with the PSCCH. Therefore, a start location of sub-channels of each PSSCH is a possible frequency domain start location of a PSCCH. Frequency domain ranges of the PSCCH resource pool and the PSSCH resource pool may be determined based on the foregoing parameters. FIG. 10 is a schematic diagram of PSCCH and PSSCH resource pools.

Usually, the PSCCH is used to carry sidelink control information related to resource listening. In some implementations, the PSCCH may include: a priority of scheduled transmission, frequency domain resource assignmentassignment, time domain resource assignment, a reference signal pattern of the PSSCH, a second-stage sidelink control information (SCI) format, a second-stage SCI bit rate offset, a quantity of PSSCH demodulation reference signal (DMRS) ports, a modulation and coding scheme (MCS), an MCS table indicator, a quantity of physical sidelink feedback channel (PSFCH) symbols, a resource reservation period, a reserved bit, and the like.

The frequency domain resource assignment is used to indicate a quantity of frequency domain resources of a PSSCH scheduled in a current slot by the PSCCH, and a quantity and a start location of at most two reserved retransmission resources.

Time domain resource assignment is used to indicate time domain locations of at most two retransmission resources.

The resource reservation period is used to reserve a resource used for sending another TB in a next period. Usually, this information bit field does not exist when resource reservation between TBs is not activated in a resource pool configuration.

The reserved bits usually have 2 bits to 4 bits, which may be configured by a network or preconfigured.

Because the PSCCH and the scheduled PSSCH are sent in the same slot, and a start location of PRBs occupied by the PSCCH may be a start location of the first sub-channel of the scheduled PSSCH, the foregoing PSCCH (that is, an SCI format 1-A) does not explicitly indicate a start location of the scheduled PSSCH in time-frequency domain.

### Determining of an NR-V2X Time Domain Resource

In NR-V2X, PSCCH/PSSCH transmission is usually based on a slot level. In other words, only one PSCCH/PSSCH can be transmitted in one slot, and transmission of a plurality of PSCCHs/PSSCHs in a time-division multiplexing (TDM) manner in one slot is not supported. In addition, PSCCHs/PSSCHs between different users may be multiplexed in a frequency division multiplexing (FDM) manner in one slot.

A time domain resource of a PSSCH in NR-V2X may be in a granularity of slot. However, NR-V2X is different from LTE-V2X in that, a PSSCH in LTE-V2X occupies all time domain symbols in a subframe, while a PSSCH in NR-V2X may occupy only some symbols in a slot. This is mainly because in an LTE system, uplink and downlink transmission are all performed in a granularity of subframe, and thus sidelink transmission is also performed in a granularity of subframe (a special subframe in a TDD system is not used for sidelink transmission). In an NR system, a flexible slot structure is used. To be specific, one slot includes both an uplink symbol and a downlink symbol, so that more flexible scheduling can be implemented and a delay can be reduced.

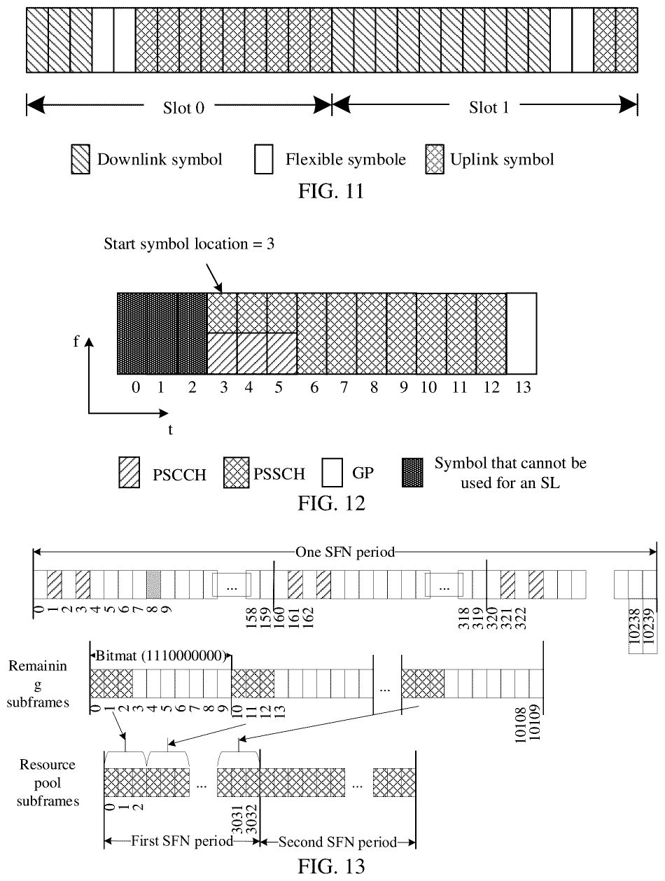

FIG. 11 is a schematic diagram of a subframe in an NR system. With reference to FIG. 11, a slot may include a downlink (DL) symbol, an uplink (UL) symbol, and a flexible symbol. The downlink symbol may be located at a start location of the slot, the uplink symbol may be located at an end location of the slot, and the flexible symbol exists between the downlink symbol and the uplink symbol. In addition, quantities of different types of symbols in each slot are configurable.

Currently, a sidelink transmission system may share a carrier with a cellular system. In this case, sidelink transmission can only use an uplink transmission resource of the cellular system. For NR-V2X, if sidelink transmission still needs to occupy all time domain symbols in one slot, a network needs to configure a slot of all uplink symbols for sidelink transmission. In this way, uplink and downlink data transmission in the NR system is greatly affected, and system performance is reduced. Therefore, in NR-V2X, it is supported that some time domain symbols in the slot are used for sidelink transmission, that is, some uplink symbols in one slot are used for sidelink transmission. In addition, an automatic gain control (AGC) symbol and a GP symbol are included in sidelink transmission. In consideration of this, if there is a relatively small quantity of uplink symbols that can be used for sidelink transmission, except the AGC symbol and the GP symbol, the remaining symbols that can be used to transmit valid data are few, and resource utilization is very low. Therefore, at least seven time domain symbols (including a guard period (GP) symbol) are occupied by sidelink transmission in NR-V2X. When the sidelink transmission system uses a dedicated carrier, that is, not sharing a transmission resource with another system, all the symbols in the slot may be used for sidelink transmission.

In NR-V2X, a start point and a length of time domain symbols used for sidelink transmission in a slot may be configured by using parameters: a start symbol location (sl-StartSymbol) and a symbol quantity (sl-LengthSymbols). A last symbol in time domain symbols used for sidelink transmission is used as a guard period GP, and only other time domain symbols can be used for a PSSCH and a PSCCH. However, if a PSFCH transmission resource is configured in a slot, the PSSCH and the PSCCH cannot occupy a time domain symbol used for PSFCH transmission and cannot occupy AGC and GP symbols before the symbol.

FIG. 12 is a schematic diagram of symbols used for sidelink transmission in a slot. With reference to FIG. 12, a network device may configure a start symbol location as 3 and a symbol quantity as 11, that is, 11 time domain symbols that start from a symbol index 3 in one slot may be used for sidelink transmission. A symbol 3 is usually used as an AGC symbol, a symbol 13 is used as a GP, and remaining symbols may be used for PSCCH and PSSCH transmission. A PSCCH occupies two time domain symbols.

It should be noted that, because data on the AGC symbol is a copy of data on the second sidelink symbol, the first sidelink symbol may also include PSCCH data.

In an NR-V2X system, a time domain resource of a resource pool is also indicated by using a bitmap. In consideration of a flexible slot structure in the NR system, a length of the bitmap is also extended, and a supported bitmap length range is [10:160]. A manner of determining, based on a bitmap, a slot location that is in an SFN period and that belongs to a resource pool is the same as that in LTE-V2X. However, there are the following two differences:

First, a total quantity of slots included in one SFN period is 10240×2^{μ}, where a parameter μ is related to a value of a subcarrier spacing.

Second, if at least one time domain symbol in time domain symbols Y, Y+1, Y+2, . . . , Y+X−1 included in one slot is not configured as an uplink symbol by using TDD-UL-DL-ConfigCommon signalling of the network device, the slot cannot be used for sidelink transmission. Herein, Y and X respectively represent sl-StartSymbol and sl-LengthSymbols.

Time domain resource selection of the resource pool may include step 1 to step 5 below.

Step 1: Remove a slot that does not belong to the resource pool in the SFN period. The slot that does not belong to the resource pool may include a synchronization slot, a slot that cannot be used for sidelink transmission, and the like. Remaining slots are expressed as a remaining slot set. The remaining slots are renumbered as (l₀, l₁, . . . , l_{(10240×2}_{^{μ}}_{-N}_{_{S_SSB}}_{-N}_{_{nonSL}}₋₁₎).

Herein, N_{S_SSB} represents a quantity of synchronization slots in one SFN period, and is related to an SSB transmission period, a quantity of SSB transmission resources configured in the period, and the like. The synchronization slot is determined based on synchronization-related configuration parameters.

N_{nonSL} represents a quantity of slots that do not meet a configuration of an uplink symbol start point and a quantity of uplink symbols in the SFN period. If at least one time domain symbol in the time domain symbols Y, Y+1, Y+2, . . . , and Y+X−1 included in the slot is not semi-statically configured as an uplink symbol, the slot cannot be used for sidelink transmission, where Y and X respectively represent sl-StartSymbol and sl-LengthSymbols.

Step 2: Determine a quantity of reserved slots and a corresponding time domain location.

If a quantity of slots in the remaining slot set cannot be exactly divided by a bitmap length, a quantity of reserved slots and a corresponding time domain location need to be determined. In some implementations, if a slot lᵣ (0≤r<10240×2^{μ}−N_{S_SSB}−N_{nonSL}) satisfies

$$r = ⌊ \frac{m \cdot ( 10240 \times {2}^{μ} - {N}_{S \_ SSB} - {N}_{nonSL} )}{{N}_{reserved}} ⌋ ,$$

the slot is a reserved slot.

Herein, N_{reserved}=(10240×2^{μ}−N_{S_SSB}−N_{nonSL}) mod L_{bitmap} represents a quantity of reserved slots, L_{bitmap} represents the bitmap length, and m=0, . . . , N_{reserved}−1.

Step 3: Remove the reserved slot from the remaining slot set, where a set of the remaining slots is expressed as a logical slot set.

All the slots in the foregoing slot set are slots that can be used in a resource pool. The slots in the logical slot set are renumbered as (t₀^{SL}, t₁^{SL}, . . . , tₘₐₓ_{^{−1}}^{SL}), where Tₘₐₓ=10240×2^{μ}−N_{S_SSB}−N_{nonSL}−N_{reserved}.

Step 4: Determine, from the logical slot set and based on the bitmap, a slot that belongs to the resource pool.

A bitmap in resource pool configuration information is (b₀, b₁, . . . , b_{L}_{_{bitmap}}₋₁). For a slot tₖ^{SL} (0≤k<(10240× 2^{μ}−N_{S_SSB}−N_{nonSL}−N_{reserved}) in the logical slot set, when b_{k′}=1 is satisfied, the slot is a slot belonging to the resource pool, where k′=k mod L_{bitmap}.

Step 5: Renumber the slots that are determined in step 4 as slots belonging to the resource pool as t′ᵢ^{SL}, where i∈{0, 1, . . . , T′ₘₐₓ−1}, and T′ₘₐₓ represents a quantity of slots included in the resource pool.

FIG. 13 is a schematic diagram of a sidelink resource selection manner. With reference to FIG. 13, one SFN period (or DEN period) includes 10240 subframes, a synchronization signal period is 160 ms, and two synchronization subframes are included in one synchronization period. Therefore, there are a total of 128 synchronization subframes in one SFN period, and a length of a bitmap used to indicate time domain resources of a resource pool is 10 bits. In this case, two reserved subframes (also referred to as “reserved time domain units” below) are needed, and a quantity of remaining subframes is (10240−128−2=10110) and can be exactly divided by the bitmap length 10. The remaining subframes are renumbered as 0, 1, 2, . . . , and 10109. First three bits of the bitmap are 1, and the remaining 7 bits are 0. In other words, in the remaining subframes, first three subframes in each 10 subframes belong to the resource pool, and the other subframes do not belong to the resource pool. The bitmap needs to be repeated for 1011 times in the remaining subframes to indicate whether each subframe belongs to the resource pool, and three subframes in each bitmap period are included. Therefore, a total of 3033 subframes in one SFN period belong to the resource pool.

### Sidelink Resource Allocation Manners

Currently, in some communications systems (for example, NR), two resource configuration manners for sidelink resources are defined, that is, a mode 1 and a mode 2.

In the mode 1, a network device schedules a sidelink resource for a terminal device.

Currently, the mode 1 may include two manners: dynamic resource allocation and a sidelink configured grant (SL CG). In dynamic resource allocation, the network device may allocate a sidelink transmission resource to the terminal by transmitting downlink control information (DCI). In the manner of a sidelink configured grant, after a sidelink resource is configured for the terminal, if the terminal has to-be-transmitted data, the terminal may transmit the data by using the configured sidelink resource, without needing to apply for another sidelink resource from the network device. Therefore, a delay of a sidelink may be reduced in the resource configuration manner of a configured grant.

The configured grant further includes two types. In a type 1 (Type1) of the configured grant, a sidelink resource configuration is only based on radio resource control (RRC) signalling. In a type 2 (Type2) of the configured grant, a sidelink resource configuration in a communications system may be configured by using both RRC signalling and layer 1 (L1) signalling, where the L1 signalling is used to indicate activation and deactivation of an RRC configuration.

In some implementations, the network device may schedule, for the terminal, a sidelink resource for a single transmission. In some other implementations, the network device may further configure a semi-persistent sidelink resource for the terminal.

In the mode 2, a terminal independently selects a sidelink resource from a resource pool.

In this mode, a process executed by the terminal includes a resource probing process and/or a resource selection process. In the resource probing process, the terminal may identify occupancy of a sidelink resource by demodulating sidelink control information (SCI). Alternatively, the terminal may identify occupancy of a sidelink resource by measuring a received power of a sidelink.

### Sidelink-Based Positioning

Sidelink-based positioning is one of enhancement solutions of R18 positioning technologies. In this topic, scenarios and requirements of supporting NR positioning cases in cellular network coverage, partially in coverage, and outside coverage are considered, and positioning requirements for V2X cases, public security cases, commercial cases, and industrial Internet of things (IIOT) cases are considered. In addition, it is considered to support the following functions: absolute positioning, distance-measuring/direction-finding, and relative positioning; study of a positioning method of combining a sidelink measurement quantity with a Uu interface measurement quantity; study of sidelink positioning reference signals, including a signal design, physical layer control signalling, resource allocation, a physical layer measurement quantity, and a related physical layer process; or study of an architecture and a signalling process of a positioning system, such as a configuration and measurement reporting.

For absolute positioning, a terminal may directly determine an absolute geographic location of the terminal based on a measurement result. This is also referred to as terminal-based absolute positioning. Alternatively, a terminal may report a measurement result to a positioning server, for example, an LMF, and then the LMF calculates an absolute location of the terminal and notifies the terminal of the absolute location. This manner is referred to as terminal-assisted absolute positioning. For distance-measuring/direction-finding or relative positioning, the terminal may estimate a relative distance and a relative direction by estimating information of a received positioning reference signal, such as a round-trip time (RTT), an angle of arrival, and received signal strength of the signal.

In some implementations, a first SL PRS resource may belong to an SL PRS resource pool. Correspondingly, a first terminal device may select the first SL PRS resource from the SL PRS resource pool. The following uses the SL PRS resource pool as an example to describe a time domain location between the SL PRS resource pool and a resource pool (also referred to as a “sidelink communication resource pool”) used for sidelink communication.

The foregoing sidelink communication resource pool may be understood as a resource pool of sidelink resources to be selected by the terminal device in the mode 2 described above. Therefore, the foregoing sidelink communication resource pool may also be referred to as a “mode−2 sidelink communication resource pool”. In some implementations, the sidelink communication resource pool may include one or more of the following sidelink resources: a sidelink resource used for PSCCH transmission, a sidelink resource used for PSSCH transmission, or a sidelink resource used for PSFCH transmission.

For time domain start locations of the two resource pools, in some implementations, the time domain start location of the SL PRS resource pool may be determined based on the time domain start location of the sidelink communication resource pool. For example, the time domain start location of the SL PRS resource pool may be the same as the time domain start location of the sidelink communication resource pool. Usually, another terminal device can recognize the sidelink communication resource pool. Therefore, when the time domain start location of the SL PRS resource pool is set in the foregoing manner, it helps the another terminal device recognize the SL PRS resource pool.

For time domain locations of the two resource pools, in some implementations, time domain resources in the SL PRS resource pool may include time domain resources in the sidelink communication resource pool. For example, a part of the time domain resources in the SL PRS resource pool may be all of the time domain resources in the sidelink communication resource pool. In some other implementations, the time domain resources in the SL PRS resource pool may be the same as the time domain resources in the sidelink communication resource pool.

For frequency domain locations of the two resource pools, in some implementations, frequency domain resources in the SL PRS resource pool may include frequency domain resources in the sidelink communication resource pool. For example, a part of the frequency domain resources in the SL PRS resource pool may be all of the frequency domain resources in the sidelink communication resource pool.

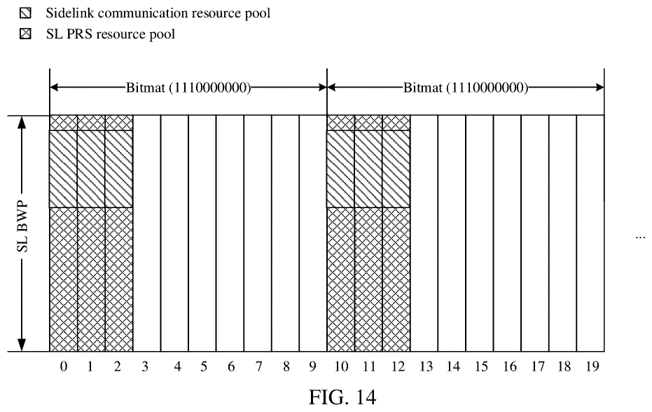

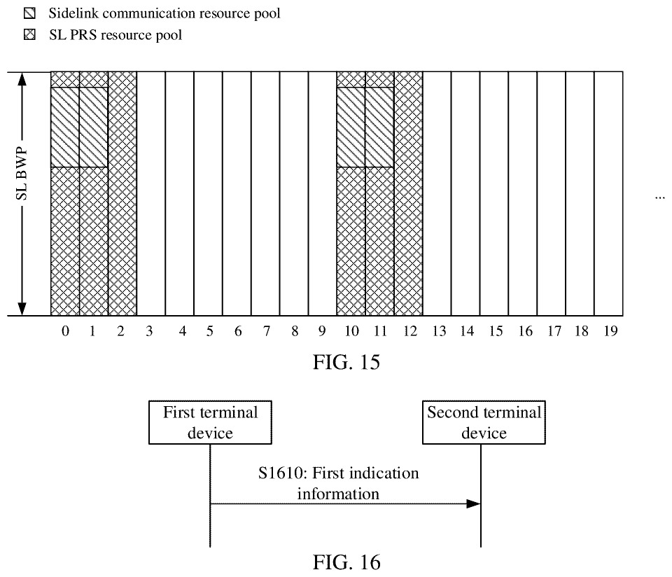

For ease of understanding, the following describes the time domain locations of the two resource pools with reference to FIG. 14 and FIG. 15. It should be noted that the following uses a slot and an SL BWP as examples to describe the two resource pools. Embodiments of this application are not limited thereto. The slot may be replaced with another time domain unit, for example, a symbol or a subframe. The SL BWP may be replaced with another frequency domain unit, for example, a sub-channel or a PRB.

FIG. 14 is a schematic diagram of an SL PRS resource pool and a sidelink communication resource pool according to an embodiment of this application. It is assumed that for time domain resources in the sidelink communication resource pool, a bitmap 1110000000 is used to indicate that first three slots (that is, slots numbered 0 to 2, and 10 to 12) in ten corresponding slots belong to the sidelink communication resource pool. Correspondingly, the SL PRS resource pool may also include slots numbered 0 to 2, and 10 to 12 in time domain. In frequency domain, the SL PRS resource pool may include a sidelink bandwidth part (SL BWP). Correspondingly, all of the frequency domain resources in the sidelink communication resource pool may be a part of frequency domain resources in the SL PRS resource pool.

FIG. 15 is a schematic diagram of an SL PRS resource pool and a sidelink communication resource pool according to another embodiment of this application. It is assumed that for time domain resources in the sidelink communication resource pool, a bitmap 1100000000 is used to indicate that first two slots (that is, slots numbered 0 and 1, and 10 and 11) in ten corresponding slots belong to the sidelink communication resource pool. Correspondingly, the SL PRS resource pool may also include slots numbered 0 to 2, and 10 to 12 in time domain. In other words, some of time domain resources in the SL PRS resource pool belong to the sidelink communication resource pool. In frequency domain, the SL PRS resource pool may include a sidelink bandwidth part (SL BWP). Correspondingly, all of frequency domain resources in the sidelink communication resource pool may be a part of frequency domain resources in the SL PRS resource pool.

It should be noted that the SL PRS resource pool in this embodiment of this application may be understood as a sidelink resource set, and a sidelink resource in the sidelink resource set may be used for SL PRS transmission. Certainly, the sidelink resource in the sidelink resource set may be further used to transmit another sidelink signal. This is not limited in embodiments of this application.

In some scenarios, an SL PRS resource may overlap a resource used for sidelink communication. For example, the SL PRS resources in the SL PRS resource pool described above overlap the sidelink resources in the sidelink communication resource pool. In this case, if a first terminal device reserves an SL PRS resource (also referred to as a “first SL PRS resource”) for sending an SL PRS, the SL PRS on the first SL PRS resource may collide with a sidelink signal sent by another terminal device. In other words, the first SL PRS resource may collide with a resource used by a second terminal device for sidelink communication.

Therefore, to reduce a collision between the first SL RRS resource and the resource used by the another terminal device for sidelink communication, in this embodiment of this application, the first terminal device may notify the another terminal device of the reserved first SL RRS resource. For ease of understanding, the following describes a communication method in embodiments of this application with reference to FIG. 16.

FIG. 16 is a schematic flowchart of a communication method according to an embodiment of this application. The method shown in FIG. 16 includes step S1610.

In step S1610, a first terminal device sends first indication information to a second terminal device. The first indication information is used to indicate reserving a first SL PRS resource in an SL PRS resource pool.

In some implementations, the foregoing first indication information may be sidelink control information, for example, may be first-stage SCI. Certainly, the foregoing first indication information may alternatively be other information. This is not limited in embodiments of this application.

The following separately describes the first SL PRS resource in embodiments of this application with reference to Embodiment 1 to Embodiment 3.

### Embodiment 1

A time domain unit in which the first SL PRS resource is located is the same as a time domain unit in which the first indication information is located.

In other words, the first terminal device indicates, by using the first indication information, only an SL PRS resource in the time domain unit in which the first indication information is located, and does not reserve an SL PRS resource in another time domain unit by using the first indication information. In other words, the first terminal device does not send the first indication information in a time domain unit 1 to indicate reserving a resource in a time domain unit 2 to send an SL PRS, where the time domain unit 1 is different from the time domain unit 2.

That the first terminal device does not reserve an SL PRS resource in another time domain unit may be understood as that the first terminal device does not reserve a resource that is in another time domain unit and that overlaps a sidelink communication resource used by another terminal device, to send an SL PRS. Certainly, the first terminal device may not reserve sidelink resources in any other time domain units.

In this embodiment of this application, the first terminal device reserves, by using the first indication information, the SL PRS resource in the time domain unit in which the first indication information is located, to facilitate reduction of a possibility of a collision between transmission of an SL PRS in another time domain unit and sidelink communication performed by the second terminal device.

In some implementations, the foregoing method may be applied to a scenario in which each time domain unit in the SL PRS resource pool may include a resource used by the second terminal device for sidelink communication, for example, the two resource pools shown in FIG. 14. Certainly, the method in embodiments of this application may be further used in another scenario, for example, the two resource pools shown in FIG. 15.

For ease of understanding, the following describes the communication method in embodiments of this application by using the two resource pools described in FIG. 14 as examples.

With reference to FIG. 14, the sidelink resources included in the SL PRS resource pool are the same as the sidelink resources included in the sidelink communication resource pool. In other words, a sidelink communication resource exists in each slot in the SL PRS resource pool. The sidelink resources in the sidelink communication resource pool may be used by the terminal device 2 for sidelink communication. In this case, if a terminal device 1 sends indication information 1 in a slot 0 to reserve an SL PRS resource 1, correspondingly, the SL PRS resource 1 is also located in the slot 0. In other words, the terminal device 1 cannot reserve an SL PRS resource in another slot (for example, the slot 1) by using the indication information 1.

In this embodiment of this application, when each slot in the SL PRS resource pool includes a resource that overlaps a sidelink communication resource pool of another terminal device, if the terminal device 1 does not reserve the SL PRS resource, the terminal device 1 may not need to send, to the another terminal device, indication information (for example, a PSCCH) for indicating the reserved SL PRS resource, thereby avoiding impact of this type of indication information on sidelink communication (for example, transmission of an SL PRS).

### Embodiment 2

The foregoing first SL PRS resource is an SL PRS resource other than a resource used for sidelink communication in the SL PRS resource pool. In other words, the first SL PRS resource does not belong to the sidelink communication resource pool of the second terminal device, that is, the first SL PRS resource is not used by the second terminal device for sidelink communication. In this case, a time domain unit in which the first SL PRS resource is located may be referred to as a “reservable time unit”.

In this embodiment of this application, the first terminal device may reserve, in the SL PRS resource pool, an SL PRS resource other than the resource used for sidelink communication, to facilitate reduction of a possibility that SL PRS transmission performed by the first terminal device collides with sidelink communication performed by the second terminal device.

In addition, in this embodiment, for another terminal other than the first terminal device, whether to reserve an SL PRS resource in the reservable time unit may be determined by detecting the first indication information, to determine whether to select the SL PRS resource in the reservable time unit, thereby reducing a possibility that SL PRS transmission performed by the first terminal device in the reservable time unit collides with SL PRS transmission performed by the another terminal device in the reservable time unit.

In some implementations, the first SL PRS resource may include a time domain unit used for sending an S-SSB, and/or a reserved time domain unit (for example, a reserved slot or a reserved subframe) in a configuration or preconfiguration of the sidelink communication resource pool.

If the first SL PRS resource includes a reserved time domain unit, the foregoing reserved time domain unit may be determined based on configuration information or preconfiguration information of the sidelink communication resource pool. For example, a reserved time unit may be indicated by a specific information field (for example, a specific bitmap) in a configuration or preconfiguration message of the resource pool.

In some implementations, the time domain unit in which the first SL PRS resource is located may be different from the time domain unit in which the first indication information is located. Certainly, the time domain unit in which the first SL PRS resource is located may also be the same time domain unit in which the first indication information is located. This is not limited in embodiments of this application.

In some implementations, the foregoing method may be applied in a scenario in which the SL PRS resource pool includes the sidelink communication resource pool of the second terminal device, for example, the two resource pools shown in FIG. 15.

The following uses the resource pools shown in FIG. 15 as examples to describe the communication method in embodiments of this application. With reference to FIG. 15, a slot 2 and a slot 12 in the SL PRS resource pool do not belong to the sidelink communication resource pool of the second terminal device. In other words, the slot 2 and the slot 12 are reservable slots. In this case, the terminal device 1 may send the indication information 1 to the terminal device 2 in the slot 0, to reserve an SL PRS resource in the slot 2 and/or the slot 12.

In this application, Embodiment 1 and Embodiment 2 above may be used separately, or Embodiment 1 and Embodiment 2 may be used in combination. When Embodiment 1 and Embodiment 2 are used in combination, whether to execute the solution in Embodiment 1 or the solution in Embodiment 2 may be determined based on whether the reservable time unit exists in the SL PRS resource pool.

In other words, if the reservable time unit exists in the SL PRS resource pool, the first terminal device may reserve the first SL PRS resource in the reservable time unit by using the solution in Embodiment 2. Otherwise, if the reservable time unit does not exist in the SL PRS resource pool, by using the solution in Embodiment 1, the first terminal device may indicate the SL PRS resource only in the time unit in which the first indication information is located. In this case, the first terminal device cannot reserve an SL PRS resource in another time unit.

### Embodiment 3

A second SL PRS resource included in the first SL PRS resource overlaps a resource used by the second terminal device for sidelink communication in the sidelink communication resource pool. The second SL PRS resource may be a part or all of the first SL PRS resource.

In some implementations, a time domain unit in which the second SL PRS resource is located is different from a time domain unit in which the first indication information is located. In other words, the time domain unit in which the second SL PRS resource is located is located after the time unit in which the first indication information is located in time domain.

In this embodiment of this application, if a part or all of the first SL PRS resource overlaps the resource used by the second terminal device for sidelink communication, the first terminal device may notify the second terminal device to reserve the first SL PRS resource by sending the first indication information, to facilitate reduction of a possibility that SL PRS transmission performed by the first terminal device collides with sidelink communication performed by the second terminal device.

In some implementations, the foregoing second SL PRS resource may include one or more SL PRS resources. When the second SL PRS resource includes a plurality of SL PRS resources, the plurality of SL PRS resources may be consecutive in time domain. Certainly, the plurality of SL PRS resources may alternatively be inconsecutive in time domain.

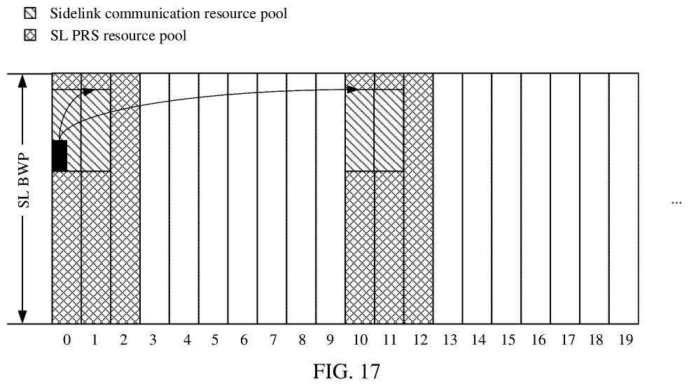

For ease of understanding, the following describes a solution of an embodiment of this application with reference to FIG. 17 by using the time domain locations of the two resource pools shown in FIG. 15 as an example. It is assumed that the terminal device 1 sends the indication information 1 in the slot 0, and the reserved second SL PRS resources are respectively located in the slot 1 and a slot 10. The second SL PRS resource in the slot 1 and the second SL PRS resource in the slot 10 are inconsecutive in time domain. Certainly, the second SL PRS resources reserved by the terminal device 1 may be respectively located in the slot 1 and the slot 2. In this case, the slot 1 and the slot 2 are consecutive in time domain.

In some scenarios, when the reserved second SL PRSs are inconsecutive in time domain, an SL PRS resource between the two second SL PRS resources may be a resource (also referred to as a “target time domain unit”) used only to transmit an SL PRS. In some implementations, the target time domain unit includes a time domain unit used for sending a sidelink synchronization signal block (S-SSB), and/or a reserved time domain unit in a configuration or preconfiguration of the sidelink communication resource pool. In this case, whether the target time domain unit is reserved by the first terminal device is a problem to be resolved.

For ease of understanding, description is further provided below with reference to FIG. 17. When the reserved second SL PRS resources are respectively located in the slot 1 and the slot 10, there is a sidelink resource in the slot 2 between the slot 1 and the slot 10. In addition, the sidelink resource in the slot 2 belongs to only the SL PRS resource pool, and does not belong to the sidelink communication resource pool. In this case, whether the sidelink resource in the slot 2 is reserved by the first terminal device is a problem to be resolved.

To resolve the foregoing problem, embodiments of this application provide two implementations. Description is provided below with reference to an implementation 1 and an implementation 2.

Implementation 1: A default target time domain unit is reserved by the first terminal device to send an SL PRS.

Still with reference to FIG. 17, when the reserved second SL PRS resources are respectively located in the slot 1 and the slot 10, there is a sidelink resource in the slot 2 between the slot 1 and the slot 10. In addition, the sidelink resource in the slot 2 belongs to only the SL PRS resource pool, and does not belong to the sidelink communication resource pool. In this case, the sidelink resource in the slot 2 may also be reserved by default by the first terminal device as a resource for sending an SL PRS.

Implementation 2: Whether the target time domain unit is reserved by the first terminal device to send an SL PRS is determined based on the first indication information. In other words, the first indication information may be used to indicate whether the target time domain unit is reserved by the first terminal device.

In some implementations, the first terminal device may indicate, by using a specific bit in a PSCCH, whether the target time domain unit is reserved. For example, the first terminal device may reuse a “PSFCH symbol quantity (PSFCH overhead indication)” field in the PSCCH to indicate whether the target time domain unit is reserved. Certainly, in this embodiment of this application, whether the target time domain unit is reserved may be alternatively indicated by using another field in the PSCCH.

The following describes the first indication information in this embodiment of this application. It should be noted that the first indication information described below may be used in combination with any one of the foregoing embodiments.

In some implementations, the first indication information further includes scheduling information, and the scheduling information is used to schedule transmission of an SL PRS on the first SL PRS resource. The scheduling information may also be referred to as “reservation information used for sending the SL PRS”.

In some implementations, the scheduling information (or the first indication information) includes one or more of the following information: information indicating a priority of transmitting the SL PRS; information indicating frequency domain resource assignment of the second SL PRS resource; information indicating time domain resource assignment of the first SL PRS resource; information indicating a reservation period of the first SL PRS resource; or information indicating a reference signal pattern of a PSSCH that carries the first indication information.

The foregoing information indicating the priority of transmitting the SL PRS may be, for example, an index of the priority of transmitting the SL PRS; or the information indicating the priority of transmitting the SL PRS may be, for example, an identifier of the priority of transmitting the SL PRS. This is not limited in embodiments of this application.

The foregoing priority of transmitting the SL PRS may be associated with a type of the first terminal device and/or a use of the SL PRS. In other words, the priority of transmitting the SL PRS may be determined based on the type of the first terminal device and/or the use of the SL PRS. The type of the first terminal device includes a common consumer electronic device (for example, a remote control or a television), a public security terminal device, and the like. The use of the SL PRS includes absolute positioning of a target object, relative positioning of a target object, direction-finding of a target object, or the like.

For example, the priority of transmitting the SL PRS is associated with the use of the SL PRS. If the SL PRS transmitted by the first terminal device is used for absolute positioning of another terminal device, the priority of transmitting the SL PRS by the first terminal device is relatively high. If the SL PRS transmitted by the first terminal device is used for relative positioning of another terminal device, the priority of transmitting the SL PRS by the first terminal device is relatively low.

For example, the priority of transmitting the SL PRS is associated with the type of the first terminal device. If the type of the first terminal device is a common electronic device, the priority of transmitting the SL PRS by the first terminal device is relatively low. If the type of the first terminal device is a public security terminal device, the priority of transmitting the SL PRS by the first terminal device is relatively high.

For example, the priority of transmitting the SL PRS is associated with the type of the first terminal device and the use of the SL PRS. If the first terminal device is a remote control, and the sent SL PRS is used to implement relative positioning or direction-finding of a television, the priority of the SL PRS is relatively low. If the first terminal device is a public security terminal device, and the sent SL PRS is used for absolute positioning of a target object, the priority of the SL PRS is relatively high.

For ease of comparison with a priority of sidelink communication, the priority of transmitting the SL PRS may be expressed by using a sidelink priority. For example, the index of the priority of transmitting the SL PRS may be an index of a sidelink priority. Certainly, in this embodiment of this application, the priority of transmitting the SL PRS may be expressed by using a dedicated priority.

For example, the indication information 1 sent by the terminal device 1 indicates that the index of the priority of transmitting the SL PRS is 0, and indication information 2 sent by the terminal device 2 indicates that an index of a priority of transmitting sidelink data (that is, a sidelink priority) is 0. In this case, the priority of transmitting the SL PRS is the same as the priority of transmitting the sidelink data.

For another example, the indication information 1 sent by the terminal device 1 indicates that the index of the priority of transmitting the SL PRS is 0, and indication information 2 sent by the terminal device 2 indicates that an index of a priority of transmitting sidelink data (that is, a sidelink priority) is 1. In this case, the priority of transmitting the SL PRS is higher than the priority of transmitting the sidelink data.

The frequency domain resource assignment of the second SL PRS resource may include a quantity of sub-channels occupied by the second SL PRS resource and/or a start location of the second SL PRS resource in frequency domain. In other words, the frequency domain resource assignment is used to indicate a quantity of sub-channels, in the sidelink communication resource pool, that overlap a frequency domain resource reserved by the first terminal device for sending an SL PRS, and/or a frequency domain start location of sub-channels, in the sidelink communication resource pool, that overlap a frequency domain resource reserved by the first terminal device for sending an SL PRS.

The information indicating the time domain resource assignment of the first SL PRS resource is used to indicate an offset of a time domain location of the first SL PRS resource relative to a time domain location of the time domain unit in which the first indication information is located.

In some implementations, the time domain resource assignment may be associated with one or more first SL PRS resources. Usually, in order that the second terminal device can recognize the foregoing time domain resource assignment information, a quantity of first SL PRS resources associated with the time domain resource assignment information may be determined based on a configuration of the sidelink communication resource pool. Certainly, the quantity of first SL PRS resources associated with the time domain resource assignment information may be separately set, and is irrelevant to the configuration of the sidelink communication resource pool. This is not limited in embodiments of this application. The following describes, by using an example in which the first SL PRS resource is an SL PRS resource 1, a solution in which the quantity of first SL PRS resources associated with the time domain resource assignment information is determined based on the configuration of the sidelink communication resource pool.

For example, if the configuration of the sidelink communication resource pool allows only one SL PRS resource to be reserved, that is, a resource pool configuration parameter sl-MaxNumPerReserve is set to 1, information of the time domain resource assignment of the SL PRS resource 1 indicates an offset of a time domain location of the SL PRS resource 1 relative to a time domain location of a time domain unit in which the indication information 1 is located.

For another example, if the configuration of the sidelink communication resource pool allows two SL PRS resources to be reserved, that is, a resource pool configuration parameter sl-MaxNumPerReserve is set to 2, information of the time domain resource assignment of the SL PRS resource 1 indicates offsets of time domain locations of first and second SL PRS resources 1 relative to a time domain location of a time domain unit in which the indication information 1 is located.

The reservation period of the first SL PRS resource is one of a plurality of reservation periods configured by using a configuration parameter of the sidelink communication resource pool. Usually, in order that the second terminal device can recognize the reservation period of the first SL PRS resource, the reservation period of the first SL PRS resource may be determined based on the configuration of the sidelink communication resource pool. Certainly, the reservation period of the first SL PRS resource may alternatively be separately set, and is irrelevant to the configuration of the sidelink communication resource pool.

In addition, in order that the second terminal device can recognize the reservation period of the first SL PRS resource, a resource pool configuration parameter “sl-ResourceReservePeriodList” needs to be adapted. The one or more resource reservation periods allowed in the sidelink communication resource pool are usually indicated by the resource pool configuration parameter “sl-ResourceReservePeriodList”. In other words, if resources of different periods are allowed to be reserved in the communication resource pool, that is, a resource pool configuration parameter “sl-MultiReserveResource” is set to “enabled”, the reservation period of the first SL PRS resource is a reservation period 1 in the foregoing plurality of reservation periods. In order that the second terminal device recognize the reservation period, the resource pool configuration parameter “sl-ResourceReservePeriodList” may be set to an index of the reservation period 1.

In some implementations, information indicating the reservation period of the first SL PRS resource may be, for example, an index, an identifier, or the like of the reservation period of the first SL PRS resource.

The information indicating the reference signal pattern of the PSSCH may be used to indicate a pattern of a reference signal of the PSSCH. Alternatively, the information of the reference signal pattern of the PSSCH may be used to determine whether to transmit a reference signal of the PSSCH.

To facilitate recognition performed by the second terminal device, if the configuration of the sidelink communication resource pool indicates performing resource listening based on the reference signal pattern of the PSCCH, the information of the reference signal pattern of the PSSCH may indicate not transmitting the reference signal of the PSSCH (for example, a PSSCH DMRS). Otherwise, if the configuration of the sidelink communication resource pool indicates performing resource listening based on the reference signal pattern of the PSSCH, the information of the reference signal pattern of the PSSCH may indicate a pattern of a reference signal of the PSSCH (for example, a PSSCH DMRS) to be transmitted. Correspondingly, the first terminal device may transmit the reference signal of the PSSCH based on the pattern indicated by the information of the reference signal pattern of the PSSCH.

In some implementations, the configuration of the sidelink communication resource pool may indicate, by using a parameter “sl-RS-ForSensing-r16”, whether to perform resource listening based on the reference signal pattern of the PSCCH or based on the reference signal pattern of a PSSCH. If the parameter “sl-RS-ForSensing-r16” is set to “PSCCH”, it indicates that resource listening is performed based on the reference signal pattern of the PSCCH. In this case, the parameter “sl-RS-ForSensing-r16” may be set to any reference signal pattern of the PSSCH allowed in a resource pool. Correspondingly, the first terminal device may not send any PSSCH DMRS.

If the parameter “sl-RS-ForSensing-r16” is set to “PSSCH”, it indicates that resource listening is performed based on the reference signal pattern of the PSSCH. In this case, the information of the reference signal pattern of the PSSCH indicates a pattern of a PSSCH reference signal sent by the first terminal device. In some implementations, the first terminal device may send the PSSCH reference signal in a time domain unit (for example, an OFDM symbol) corresponding to the indicated pattern of the PSCCH reference signal.

In some implementations, if the first terminal device sends the PSSCH reference signal, the first terminal device may send only a single-port PSSCH reference signal, for example, send only a PSSCH reference signal of a port 1000.

In some implementations, the information of the reference signal pattern of the PSSCH may be, for example, information such as an index or an identifier of the pattern.

In this embodiment of this application, in addition to the foregoing described one or more pieces of information, the scheduling information may further include one or more of the following: information indicating a second-stage SCI format (2nd-stage SCI format), information indicating a second-stage SCI bit rate offset (Beta_offset indicator), information indicating a quantity of PSSCH DMRS ports (Number of DMRS port), information indicating a modulation and coding scheme (MCS), information of an MCS table indicator (Additional MCS table indicator), information indicating a quantity of PSFCH symbols (PSFCH overhead indication), or a reserved bit (Reserved).

Usually, the foregoing information is not closely related to the reserved first SL PRS resource or sending of the SL PRS. Therefore, the foregoing information may be set to any value. In this case, the foregoing information may have no meaning. Certainly, in this embodiment of this application, the first indication information may alternatively not include the foregoing information.

For example, the field of the foregoing information indicating the second-stage SCI format may be set to any value. For another example, the information of the second-stage SCI bit rate offset may be set to any value. For another example, the information indicating the quantity of PSSCH DMRS ports may be set to 0. For another example, the information indicating the MCS may be set to any allowed value for the current sidelink communication resource pool. For another example, the MCS table indicator may be set to any allowed value for the current sidelink communication resource pool. For another example, the information indicating the quantity of PSFCH symbols may be set to any allowed value for the current sidelink communication resource pool. For another example, the reserved bit may be set to any allowed value for the current sidelink communication resource pool.

In some cases, if the time domain unit in which the first SL PRS resource is located is different from the time domain unit in which the first indication information is located, the first indication information may alternatively be used to indicate reserving a resource (also referred to as a third SL PRS resource) that is located in the same time domain unit as the first indication information.

In some implementations, the first indication information may be used to indicate a frequency domain location of the third SL PRS resource. For example, the first indication information may be used to indicate a frequency domain offset value of the third SL PRS resource relative to the frequency domain unit in which the first indication information is located. The frequency domain offset value may be expressed, for example, by using a quantity of resource elements (RE).

For example, the first indication information is carried in the PSCCH. The first indication information may indicate the frequency domain offset value of the third SL PRS resource by using a second-stage SCI format field. If a size of the second-stage SCI format field is 2 bits, four frequency domain offsets can be indicated.

As described above, the first indication information is used to indicate the reserved first SL PRS resource (or the first indication information is used to schedule an SL PRS). In some scenarios, the first indication information may be further used to schedule a PSSCH. For example, when the first indication information is SCI, the SCI may be used to schedule the SL PRS or the PSSCH. Therefore, for ease of distinguishing, type information may be added to the first indication information, and the type information may be used to indicate whether the first indication information is used to schedule the PSCCH or the SL PRS.

In some implementations, if the first indication information is carried in the PSSCH, the type information may be carried in a reserved bit field. For example, if all reserved bits in the reserved bit field are set to 1, it indicates that the first indication information is used to schedule the SL PRS. Otherwise, if at least one of all reserved bits in the reserved bit field is set to 0, it indicates that the first indication information is used to schedule the PSSCH.

For another example, the type information may be carried by using an MCS field. For example, when a value of the MCS field is 29, it indicates that the first indication information is used to schedule the SL PRS. Otherwise, when a value of the MCS field is not 29, it indicates that the first indication information is used to schedule the PSSCH.

In embodiments of this application, there are many manners of indicating the type information by using various fields of the PSSCH. In embodiments of this application, the type information may be indicated by jointly using values of a plurality of fields of the PSSCH. For brevity, examples are not listed below one by one.

The foregoing describes the first indication information in embodiments of this application. It should be noted that the first indication information may include a part or all of the foregoing information. This is not limited in embodiments of this application.

As described above, the SL PRS resource may be reserved according to a reservation period. The following describes a manner of determining an SL PRS resource based on a reservation period in embodiments of this application.

In some implementations, if a value of a reservation period field in the first indication information is Pᵣₛᵥₚ, the second terminal device may convert Pᵣₛᵥₚ, according to a formula

$${P}_{rsvp}^{′} = ⌈ \frac{T {′}_{max}}{1 \; 0240 ms} \times {P}_{rsvp} ⌉ ,$$

into a quantity P′ᵣₛᵥₚ of reserved time domain units, where T′ₘₐₓ indicates a quantity of time domain units (for example, slots) included in the sidelink communication resource pool in 10240 ms.

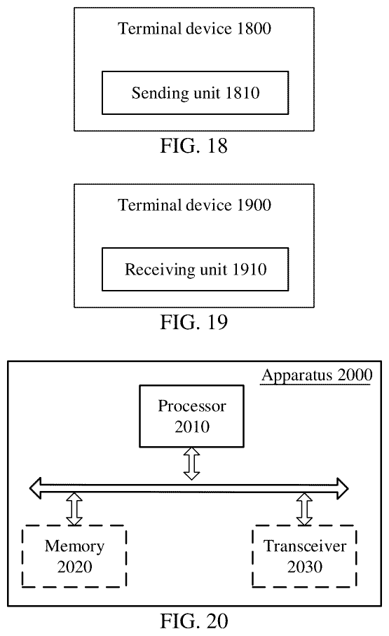

The foregoing describes in detail the method embodiments of this application with reference to FIG. 1 to FIG. 17. The following describes in detail apparatus embodiments of this application with reference to FIG. 18 to FIG. 20. It should be understood that the description of the method embodiments corresponds to the description of the apparatus embodiments, and therefore, for parts that are not described in detail, refer to the foregoing method embodiments.

FIG. 18 is a schematic diagram of a terminal device according to an embodiment of this application. The terminal device in FIG. 18 may be the foregoing described first terminal device. The first terminal device 1800 shown in FIG. 18 includes a sending unit 1810.

The sending unit 1810 is configured to send first indication information to a second terminal device. The first indication information is used to indicate reserving a first SL PRS resource in an SL PRS resource pool. The first SL PRS resource satisfies one of the following: a time domain unit in which the first SL PRS resource is located is the same as a time domain unit in which the first indication information is located; the first SL PRS resource is an SL PRS resource other than a resource used for sidelink communication in the SL PRS resource pool; or a second SL PRS resource included in the first SL PRS resource overlaps a resource that is used by the second terminal device for sidelink communication in a sidelink communication resource pool.

In a possible implementation, if the first SL PRS resource includes the second SL PRS resource, a time domain unit in which the second SL PRS resource is located is different from the time domain unit in which the first indication information is located.

In a possible implementation, the first indication information further includes scheduling information, and the scheduling information is used to schedule transmission of an SL PRS on the first SL PRS resource.

In a possible implementation, the scheduling information includes one or more of the following information: information indicating a priority of transmitting the SL PRS; information indicating frequency domain resource assignment of the second SL PRS resource; information indicating time domain resource assignment of the first SL PRS resource; information indicating a reservation period of the first SL PRS resource; or information indicating a reference signal pattern of a PSSCH that carries the first indication information.

In a possible implementation, the scheduling information includes the information indicating the priority of transmitting the SL PRS, and the priority of transmitting the SL PRS is associated with a type of the first terminal device and/or a use of the SL PRS.

In a possible implementation, the scheduling information includes information indicating a priority of transmitting the SL PRS, and the priority of transmitting the SL PRS is indicated by using a sidelink priority index.

In a possible implementation, the scheduling information includes information indicating frequency domain resource assignment of the second SL PRS resource, and the information of the frequency domain resource assignment includes a quantity of sub-channels occupied by the second SL PRS resource and/or a start location of the second SL PRS resource in frequency domain.

In a possible implementation, the scheduling information includes information indicating time domain resource assignment of the first SL PRS resource, and the information of the time domain resource assignment is used to indicate an offset of a time domain location of the first SL PRS resource relative to a time domain location of the time domain unit in which the first indication information is located.

In a possible implementation, the scheduling information includes information indicating a reservation period of the first SL PRS resource, and the reservation period of the first SL PRS resource is one of a plurality of reservation periods configured by using a configuration parameter of the sidelink communication resource pool.

In a possible implementation, the scheduling information includes information about a reference signal pattern of a PSSCH, and if a configuration of the sidelink communication resource pool indicates performing resource listening based on the reference signal pattern of the PSCCH, the information about the reference signal pattern of the PSSCH indicates not transmitting a reference signal of the PSSCH.

In a possible implementation, a target time domain unit is included between the time domain unit in which the first indication information is located and the time domain unit in which the first SL PRS resource is located, and the target time domain unit belongs to the SL PRS resource pool and does not belong to the sidelink communication resource pool; and the target time domain unit is reserved by the first terminal device for sending an SL PRS; or whether the target time domain unit is reserved by the first terminal device for sending an SL PRS is determined based on the first indication information.

In a possible implementation, the target time domain unit includes a time domain unit used for sending a sidelink synchronization signal block S-SSB, and/or a reserved time domain unit in a configuration or preconfiguration of the sidelink communication resource pool.

In a possible implementation, the first indication information is further used to indicate a third SL PRS resource in the SL PRS resource pool, and a time domain unit in which the third SL PRS resource is located is the same as the time domain unit in which the first indication information is located.

In a possible implementation, the first indication information includes type information of the first indication information, a first type indicated by the type information means that the first indication information is used to schedule a PSSCH, and a second type indicated by the type information means that the first indication information is used to schedule an SL PRS.

In a possible implementation, a time domain start location of the SL PRS resource pool is determined based on a time domain start location of the sidelink communication resource pool.

In a possible implementation, the time domain start location of the SL PRS resource pool is the same as the time domain start location of the sidelink communication resource pool.

In a possible implementation, the SL PRS resource pool includes a part or all of the sidelink communication resource pool; or the SL PRS resource pool includes the sidelink communication resource pool.

In a possible implementation, if the time domain unit in which the first SL PRS resource is located is the same as the time domain unit in which the first indication information is located, the SL PRS resource pool includes the sidelink communication resource pool.

In a possible implementation, if the first SL PRS resource is the SL PRS resource other than the resource used for sidelink communication in the SL PRS resource pool, the first SL PRS resource includes a time domain unit used for sending an S-SSB and/or a reserved time domain unit in a configuration or preconfiguration of the sidelink communication resource pool.

In a possible implementation, the first SL PRS resource includes the reserved time domain unit in the configuration or preconfiguration of the sidelink communication resource pool, and the reserved time domain unit is determined based on configuration information or preconfiguration information of the sidelink communication resource pool.

FIG. 19 is a schematic diagram of a terminal device according to an embodiment of this application. The terminal device shown in FIG. 19 may be the foregoing described second terminal device. The second terminal device 1900 shown in FIG. 19 includes a receiving unit 1910.

The receiving unit 1910 is configured to receive first indication information sent by a first terminal device. The first indication information is used to indicate reserving a first SL PRS resource in an SL PRS resource pool. The first SL PRS resource satisfies one of the following: a time domain unit in which the first SL PRS resource is located is the same as a time domain unit in which the first indication information is located; the first SL PRS resource is an SL PRS resource other than a resource used for sidelink communication in the SL PRS resource pool; or a second SL PRS resource included in the first SL PRS resource overlaps a resource that is used by the second terminal device for sidelink communication in a sidelink communication resource pool.

In a possible implementation, if the first SL PRS resource includes the second SL PRS resource, the time domain unit in which the first SL PRS resource is located is different from the time domain unit in which the first indication information is located.

In a possible implementation, the first indication information further includes scheduling information, and the scheduling information is used to schedule transmission of an SL PRS on the first SL PRS resource.

In a possible implementation, the scheduling information includes one or more of the following information: information indicating a priority of transmitting the SL PRS; information indicating frequency domain resource assignment of the second SL PRS resource; information indicating time domain resource assignment of the first SL PRS resource; information indicating a reservation period of the first SL PRS resource; or information indicating a reference signal pattern of a PSSCH that carries the first indication information.

In a possible implementation, the scheduling information includes the information indicating the priority of transmitting the SL PRS, and the priority of transmitting the SL PRS is associated with a type of the first terminal device and/or a use of the SL PRS.

In a possible implementation, the scheduling information includes information indicating a priority of transmitting the SL PRS, and the priority of transmitting the SL PRS is indicated by using a sidelink priority.

In a possible implementation, the scheduling information includes information indicating frequency domain resource assignment of the second SL PRS resource, and the information of the frequency domain resource assignment includes a quantity of sub-channels occupied by the second SL PRS resource and/or a start location of the second SL PRS resource in frequency domain.

In a possible implementation, the scheduling information includes information indicating time domain resource assignment of the first SL PRS resource, and the information of the time domain resource assignment is used to indicate an offset of a time domain location of the first SL PRS resource relative to a time domain location of the time domain unit in which the first indication information is located.

In a possible implementation, the scheduling information includes information indicating a reservation period of the first SL PRS resource, and the reservation period of the first SL PRS resource is one of a plurality of reservation periods configured by using a configuration parameter of the sidelink communication resource pool.

In a possible implementation, the scheduling information includes information about a reference signal pattern of a PSSCH, and if a configuration of the sidelink communication resource pool indicates performing resource listening based on the reference signal pattern of the PSCCH, the information of the reference signal pattern of the PSSCH indicates not transmitting a reference signal of the PSSCH.

In a possible implementation, a target time domain unit is included between the time domain unit in which the first indication information is located and the time domain unit in which the first SL PRS resource is located, and the target time domain unit belongs to the SL PRS resource pool and does not belong to the sidelink communication resource pool; and the target time domain unit is reserved by the first terminal device for sending an SL PRS; or whether the target time domain unit is reserved by the first terminal device for sending an SL PRS is determined based on the first indication information.

In a possible implementation, the target time domain unit includes a time domain unit used for sending an SSB, and/or a reserved time domain unit in a configuration or preconfiguration of the sidelink communication resource pool.

In a possible implementation, the first indication information is further used to indicate reserving a third SL PRS resource in the SL PRS resource pool, and a time domain unit in which the third SL PRS resource is located is the same as the time domain unit in which the first indication information is located.

In a possible implementation, the first indication information includes type information of the first indication information, a first type indicated by the type information means that the first indication information is used to schedule a PSSCH, and a second type indicated by the type information means that the first indication information is used to schedule an SL PRS.

In a possible implementation, a time domain start location of the SL PRS resource pool is determined based on a time domain start location of the sidelink communication resource pool.

In a possible implementation, the time domain start location of the SL PRS resource pool is the same as the time domain start location of the sidelink communication resource pool.

In a possible implementation, the SL PRS resource pool includes a part or all of the sidelink communication resource pool; or the SL PRS resource pool includes the sidelink communication resource pool.

In a possible implementation, if the time domain unit in which the first SL PRS resource is located is the same as the time domain unit in which the first indication information is located, the SL PRS resource pool includes the sidelink communication resource pool.

In a possible implementation, if the first SL PRS resource is the SL PRS resource other than the resource used for sidelink communication in the SL PRS resource pool, the first SL PRS resource includes a time domain unit used for sending an SSB and/or a reserved time domain unit in a configuration or preconfiguration of the sidelink communication resource pool.

In a possible implementation, the first SL PRS resource includes the reserved time domain unit in the configuration or preconfiguration of the sidelink communication resource pool, and the reserved time domain unit is determined based on configuration information or preconfiguration information of the sidelink communication resource pool.

In an optional embodiment, the sending unit 1810 may be a transceiver 2040. The terminal device 1800 may further include a processor 2010 and a memory 2020, as shown in FIG. 20.

In an optional embodiment, the receiving unit 1910 may be a transceiver 2040. The terminal device 1900 may further include a processor 2010 and a memory 2020, as shown in FIG. 20.

FIG. 20 is a schematic diagram of a structure of a communications apparatus according to an embodiment of this application. Dashed lines in FIG. 20 indicate that the unit or module is optional. The apparatus 2000 may be configured to implement the methods described in the foregoing method embodiments. The apparatus 2000 may be a chip, a terminal device, or a network device.

The apparatus 2000 may include one or more processors 2010. The processor 2010 may support the apparatus 2000 in implementing the methods described in the foregoing method embodiments. The processor 2010 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The apparatus 2000 may further include one or more memories 2020. The memory 2020 stores a program. The program may be executed by the processor 2010 to cause the processor 2010 to perform the methods described in the foregoing method embodiments. The memory 2020 may be independent of the processor 2010 or may be integrated into the processor 2010.

The apparatus 2000 may further include a transceiver 2030. The processor 2010 may communicate with another device or chip through the transceiver 2030. For example, the processor 2010 may transmit data to and receive data from another device or chip through the transceiver 2030.

An embodiment of this application further provides a computer-readable storage medium, configured to store a program. The computer-readable storage medium may be applied to a terminal device or a network device provided in embodiments of this application, and the program causes a computer to execute the methods to be executed by the terminal device or the network device in various embodiments of this application.

An embodiment of this application further provides a computer program product. The computer program product includes a program. The computer program product may be applied to a terminal device or a network device provided in embodiments of this application, and the program causes a computer to perform the methods performed by the terminal device or the network device in various embodiments of this application.

An embodiment of this application further provides a computer program. The computer program may be applied to a terminal device or a network device provided in embodiments of this application, and the computer program causes a computer to perform the methods performed by the terminal device or the network device in various embodiments of this application.

It should be understood that the terms “system” and “network” in this application may be used interchangeably. In addition, the terms used in this application are merely used to explain the specific embodiments of this application, and are not intended to limit this application. The terms “first”, “second”, “third”, “fourth”, and the like in the specification, claims, and accompanying drawings of this application are used for distinguishing different objects from each other, rather than defining a specific order. In addition, the terms “comprise” and “have” and any variations thereof are intended to cover a non-exclusive inclusion.

In embodiments of this application, the “indication” mentioned may be a direct indication or an indirect indication, or indicate an association. For example, if A indicates B, it may mean that A directly indicates B, for example, B can be obtained from A. Alternatively, it may mean that A indirectly indicates B, for example, A indicates C, and B can be obtained from C. Alternatively, it may mean that there is an association relationship between A and B.

In embodiments of this application, “B corresponding to A” means that B is associated with A, and B may be determined based on A. However, it should be further understood that determining B based on A does not mean determining B based on only A, but instead B may be determined based on A and/or other information.

In embodiments of this application, the term “corresponding” may mean that there is a direct or indirect correspondence between two elements, or that there is an association between two elements, or that there is a relationship of “indicating” and “being indicated”, “configuring” and “being configured”, or the like.

In embodiments of this application, “pre-definition” or “pre-configuration” can be implemented by pre-storing corresponding code or a corresponding table in a device (for example, including a terminal device and a network device) or in other manners that can be used for indicating related information. A specific implementation thereof is not limited in this application. For example, predefining may indicate being defined in a protocol.

In embodiments of this application, the “protocol” may indicate a standard protocol in the communications field, which may include, for example, an LTE protocol, an NR protocol, and a related protocol applied to a future communications system. This is not limited in this application.

In embodiments of this application, the term “and/or” is merely an association relationship that describes associated objects, and represents that there may be three relationships. For example, A and/or B may represent three cases: only A exists, both A and B exist, and only B exists. In addition, the character “/” in the specification generally indicates an “or” relationship between the associated objects.

In embodiments of this application, sequence numbers of the foregoing processes do not mean execution sequences. The execution sequences of the processes should be determined according to functions and internal logic of the processes, and should not be construed as any limitation on the implementation processes of embodiments of this application.

In several embodiments provided in this application, it should be understood that the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented as indirect couplings or communication connections through some interfaces, apparatuses or units, and may be implemented in electrical, mechanical, or other forms.

The units described as separate parts may be or may not be physically separate, and parts displayed as units may be or may not be physical units, and may be at one location, or may be distributed on a plurality of network elements. Some or all of the units may be selected according to actual requirements to achieve the objective of the solutions of embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When the software is used to implement embodiments, all or some of embodiments may be implemented in a form of a computer program product. The computer program product includes one or more computer instructions. When the computer program instructions are loaded and executed on a computer, the procedures or functions according to embodiments of this application are all or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, radio, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A first terminal device, comprising a processor configured to perform an operation of:
sending first indication information to a second terminal device, wherein the first indication information is used to indicate reserving a first SL PRS resource in an SL PRS resource pool, and the first SL PRS resource satisfies one of following:
a time domain unit in which the first SL PRS resource is located is the same as a time domain unit in which the first indication information is located;
the first SL PRS resource is an SL PRS resource other than a resource used for sidelink communication in the SL PRS resource pool; or
a second SL PRS resource comprised in the first SL PRS resource overlaps a resource that is used by the second terminal device for sidelink communication in a sidelink communication resource pool.

2. The first terminal device according to claim 1, wherein the first indication information further comprises scheduling information, and the scheduling information is used to schedule transmission of an SL PRS on the first SL PRS resource.

3. The first terminal device according to claim 2, wherein the scheduling information comprises one or more of following information:
information indicating a priority of transmitting the SL PRS;
information indicating frequency domain resource assignment of the second SL PRS resource;
information indicating time domain resource assignment of the first SL PRS resource;
information indicating a reservation period of the first SL PRS resource; or
information indicating a reference signal pattern of a PSSCH that carries the first indication information.

4. The first terminal device according to claim 2, wherein the scheduling information comprises information indicating a priority of transmitting the SL PRS, and the priority of transmitting the SL PRS is associated with a type of the first terminal device and/or a use of the SL PRS.

5. The first terminal device according to claim 2, wherein the scheduling information comprises information indicating frequency domain resource assignment of the second SL PRS resource, and the information of the frequency domain resource assignment comprises a quantity of sub-channels occupied by the second SL PRS resource and/or a start location of the second SL PRS resource in frequency domain.

6. The first terminal device according to claim 2, wherein the scheduling information comprises information indicating a reservation period of the first SL PRS resource, and the reservation period of the first SL PRS resource is one of a plurality of reservation periods configured by using a configuration parameter of the sidelink communication resource pool.

7. The first terminal device according to claim 1, wherein the first indication information comprises type information of the first indication information, a first type indicated by the type information means that the first indication information is used to schedule a PSSCH, and a second type indicated by the type information means that the first indication information is used to schedule an SL PRS.

8. The first terminal device according to claim 1, wherein a time domain start location of the SL PRS resource pool is determined based on a time domain start location of the sidelink communication resource pool;
wherein the time domain start location of the SL PRS resource pool is the same as the time domain start location of the sidelink communication resource pool.

9. The first terminal device according to claim 1, wherein if the first SL PRS resource comprises the second SL PRS resource, a time domain unit in which the second SL PRS resource is located is different from the time domain unit in which the first indication information is located; and
the SL PRS resource pool comprises a part or all of the sidelink communication resource pool; or
the SL PRS resource pool comprises the sidelink communication resource pool.

10. The first terminal device according to claim 1, wherein if the first SL PRS resource comprises the second SL PRS resource, a time domain unit in which the second SL PRS resource is located is different from the time domain unit in which the first indication information is located; and if the time domain unit in which the first SL PRS resource is located is the same as the time domain unit in which the first indication information is located, the SL PRS resource pool comprises the sidelink communication resource pool.

11. A second terminal device, comprising a processor configured to perform an operation of:
receiving first indication information sent by a first terminal device, wherein the first indication information is used to indicate reserving a first SL PRS resource in an SL PRS resource pool, and the first SL PRS resource satisfies one of following:
a time domain unit in which the first SL PRS resource is located is the same as a time domain unit in which the first indication information is located;
the first SL PRS resource is an SL PRS resource other than a resource used for sidelink communication in the SL PRS resource pool; or
a second SL PRS resource in the first SL PRS resource overlaps a resource that is used by the second terminal device for sidelink communication in a sidelink communication resource pool.

12. The second terminal device according to claim 11, wherein the first indication information further comprises scheduling information, and the scheduling information is used to schedule transmission of an SL PRS on the first SL PRS resource.

13. The second terminal device according to claim 12, wherein the scheduling information comprises one or more of following information:
information indicating a priority of transmitting the SL PRS;
information indicating frequency domain resource assignment of the second SL PRS resource;
information indicating time domain resource assignment of the first SL PRS resource;
information indicating a reservation period of the first SL PRS resource; or
information indicating a reference signal pattern of a PSSCH that carries the first indication information.

14. The second terminal device according to claim 12, wherein the scheduling information comprises information indicating a priority of transmitting the SL PRS, and the priority of transmitting the SL PRS is associated with a type of the first terminal device and/or a use of the SL PRS.

15. The second terminal device according to claim 12, wherein the scheduling information comprises information indicating frequency domain resource assignment of the second SL PRS resource, and the information of the frequency domain resource assignment comprises a quantity of sub-channels occupied by the second SL PRS resource and/or a start location of the second SL PRS resource in frequency domain.

16. The second terminal device according to claim 12, wherein the scheduling information comprises information indicating a reservation period of the first SL PRS resource, and the reservation period of the first SL PRS resource is one of a plurality of reservation periods configured by using a configuration parameter of the sidelink communication resource pool.

17. The second terminal device according to claim 11, wherein the first indication information comprises type information of the first indication information, a first type indicated by the type information means that the first indication information is used to schedule a PSSCH, and a second type indicated by the type information means that the first indication information is used to schedule an SL PRS.

18. The second terminal device according to claim 11, wherein a time domain start location of the SL PRS resource pool is determined based on a time domain start location of the sidelink communication resource pool;
wherein the time domain start location of the SL PRS resource pool is the same as the time domain start location of the sidelink communication resource pool.

19. The second terminal device according to claim 11, wherein if the first SL PRS resource comprises the second SL PRS resource, a time domain unit in which the second SL PRS resource is located is different from the time domain unit in which the first indication information is located; and
the SL PRS resource pool comprises a part or all of the sidelink communication resource pool; or
the SL PRS resource pool comprises the sidelink communication resource pool.

20. The second terminal device according to claim 11, wherein if the first SL PRS resource comprises the second SL PRS resource, a time domain unit in which the second SL PRS resource is located is different from the time domain unit in which the first indication information is located; if the time domain unit in which the first SL PRS resource is located is the same as the time domain unit in which the first indication information is located, the SL PRS resource pool comprises the sidelink communication resource pool.
